(19) United States
(12) Patent Application Publication
(10) Pub. No.: US 2024/0300103 A1
(43) Pub. Date: Sep. 12, 2024

(54) ROBOT TEACHING DEVICE AND PROGRAM FOR GENERATING ROBOT PROGRAM

(71) Applicant: FANUC CORPORATION, Minamitsuru-gun, Yamanashi (JP)

(72) Inventors: Shunta OZAKI, Yamanashi (JP); Gou INABA, Yamanashi (JP); Yuusuke KURIHARA, Yamanashi (JP)

(21) Appl. No.: 18/271,110

(22) PCT Filed: Jan. 7, 2022
(86) PCT No.: PCT/JP2022/000338

§ 371 Date: Jul. 6, 2023

(30) Foreign Application Priority Data
Jan. 14, 2021 (JP) 2021-004342

(51) Int. Cl. B25J 9/16

(52) U.S. Cl. CPC B25J 9/1661; G05B 2219/40397

(57) ABSTRACT

In the present invention, robot commands are displayed together in order to facilitate the understanding of the flow of robot commands. This robot teaching device comprises: a display unit; an edit screen image control unit for displaying, on the display unit, an edit screen image for editing a robot program that teaches how to move a robot; and a wizard control unit that, when a robot command is added to the robot program in the edit screen image, displays at least a wizard for setting a parameter value of the robot command on the display unit. The robot command added in the edit screen image may be a representative command associated with the addition of at least one other robot command besides the aforementioned robot command, and the representative command may be deleted from the robot program after the wizard has ended.

### TECHNICAL FIELD

The present invention relates to a robot teaching device and a program for generating a robot program, particularly a robot teaching device that generates a robot program for teaching a robot to move and a program for generating the robot program.

### BACKGROUND ART

Generation of a robot program is required in order for a robot to perform intended work. The robot program can be generated when a command selected from a menu shown on a teaching console is added to the robot program. A user designates a robot or a peripheral device to move or to handle an object using a program command. Patent Document 1, for example, describes a programming method for a system including a robot.

Patent Document 1 describes a programming method of displaying information required for the programming in windows of different hierarchical levels on a display screen of a device such as a personal computer. An operator develops a sequence of each level to be executed by the robot system on each window. The sequence is described with icons (graphical symbols) shown on each window. At level 1, a sequence of joining subassemblies, which are components of a product, to complete the product is developed. At level 2, a sequence of assembling parts of each of the subassemblies included in the sequence at level 1 is developed. At level 3, a work sequence for each of the parts included in the sequence developed at level 2 is developed. At level 4, for every work included in the work sequence developed at level 3, an operation sequence required for performing this work is generated as imperatives described in a programming language corresponding to a device performing the processes.
Patent Document 1: Japanese Unexamined Patent Application, Publication No. H8-249026

### DISCLOSURE OF THE INVENTION

### Problems to be Solved by the Invention

A robot program is required to set not only a single command, but a combination of a plurality of commands and parameter values of the commands. Programming to generate robot programs is difficult for a beginner to robot operation. Thus, the commands are desired to be collectively displayed for easy understanding of the flow of the commands. It is also desirable that for the sequence of program creation to be easy to understand, and for the programming to take as little time and effort as possible.

### Means for Solving the Problems

(1) A first aspect of the present disclosure is directed to a robot teaching device including: a display; an editing screen controller that displays an editing screen for editing a robot program that teaches motion of a robot on the display; and a wizard controller that display, when a robot command is added to the robot program on the editing screen, a wizard for setting at least a parameter value of the robot command on the display.

(2) A second aspect of the present disclosure is directed to a robot teaching device including: a display; an editing screen controller that displays an editing screen for editing a robot program that teaches motion of a robot on the display; and a command adder that adds, when a robot command is added to the robot program on the editing screen, at least one other robot command other than the added robot command to the robot program.

(3) A third aspect of the present disclosure is directed to a robot teaching device including: a display; an editing screen controller that displays an editing screen for editing a robot program that teaches motion of a robot on the display; and a wizard controller that shows, when a robot command is added to the robot program on the editing screen, a wizard for adding at least one other robot command other than the added robot command to the robot program, in which the robot command added on the editing screen is a representative command that is accompanied by addition of at least one other robot command other than the added robot command, and the representative command is deleted from the robot program after the wizard ends.

(4) A fourth aspect of the present disclosure is directed to a program for generating a robot program, the program causing a computer as a robot teaching device to execute: a function of displaying an editing screen for editing a robot program that teaches motion of a robot on the display; and a function of displaying, when a robot command is added to the robot program on the editing screen, a wizard for setting at least a parameter value of the robot command on the display.

(5) A fifth aspect of the present disclosure is directed to a program for generating a robot program, the program causing a display to execute: a function of displaying an editing screen for editing a robot program that teaches motion of a robot on the display; and a function of adding, when a robot command is added to the robot program on the editing screen, at least one other robot command other than the added robot command to the robot program.

(6) A sixth aspect of the present disclosure is directed to a program for generating a robot program, the program causing a computer as a robot teaching device to execute: a function of displaying an editing screen for editing a robot program that teaches motion of a robot on the display; and a function of displaying, when a robot command is added to the robot program on the editing screen, a wizard for adding at least one other robot command other than the added robot command to the robot program, in which the robot command added on the editing screen is a representative command that is accompanied by addition of at least one other robot command other than the added robot command, and the representative command is deleted from the robot program after the wizard ends.

### Effects of the Invention

According to the aspects of the present disclosure, robot commands can be collectively displayed to facilitate understanding of the flow of the robot commands. This allows a user to easily understand the sequence of programming creation and can reduce the time and effort required for the programming.

### BRIEF DESCRIPTION OF THE DRAWINGS

FIG. 1 is a block diagram illustrating a robot system including a robot teaching device of a first embodiment of the present disclosure;

FIG. 2 is a functional block diagram of the robot teaching device;

FIG. 3 is a view illustrating examples of a program editing screen and icons;

FIG. 4 is a view illustrating an example of a wizard screen of the first page for palletizing;

FIG. 5 is a view illustrating the contents that appear in a section 130A on the wizard screen of the first page for the palletizing;

FIG. 6 is a view illustrating an example of a wizard screen of the last page for the palletizing;

FIG. 7 is a view illustrating part of a program editing screen with a set of commands inserted in an area 110A;

FIG. 8 is a view illustrating a stacking operation of a gripping hand;

FIG. 9 is a flowchart showing operations of the robot teaching device of the first embodiment;

FIG. 10 is a view illustrating a pop-up window;

FIG. 11 is a view illustrating an example of a program editing screen with a set of commands added;

FIG. 12 is a functional block diagram of a robot teaching device of a second embodiment of the present disclosure and is a block diagram illustrating a variation of a machine tool;

FIG. 13 is a flowchart showing operations of the robot teaching device of the second embodiment;

FIG. 14 is a view illustrating an example of a program editing screen of a robot teaching device of a third embodiment of the present disclosure;

FIG. 15 is a view illustrating an example of a wizard screen of the first page for trajectory teaching;

FIG. 16 is a view illustrating an example of a program editing screen with a set of commands added;

FIG. 17 is a flowchart showing operations of the robot teaching device of the third embodiment; and

FIG. 18 is a view illustrating an example of a program editing screen using blocks.

### PREFERRED MODE FOR CARRYING OUT THE INVENTION

Embodiments of the present disclosure will be described below with reference to the drawings.

### First Embodiment

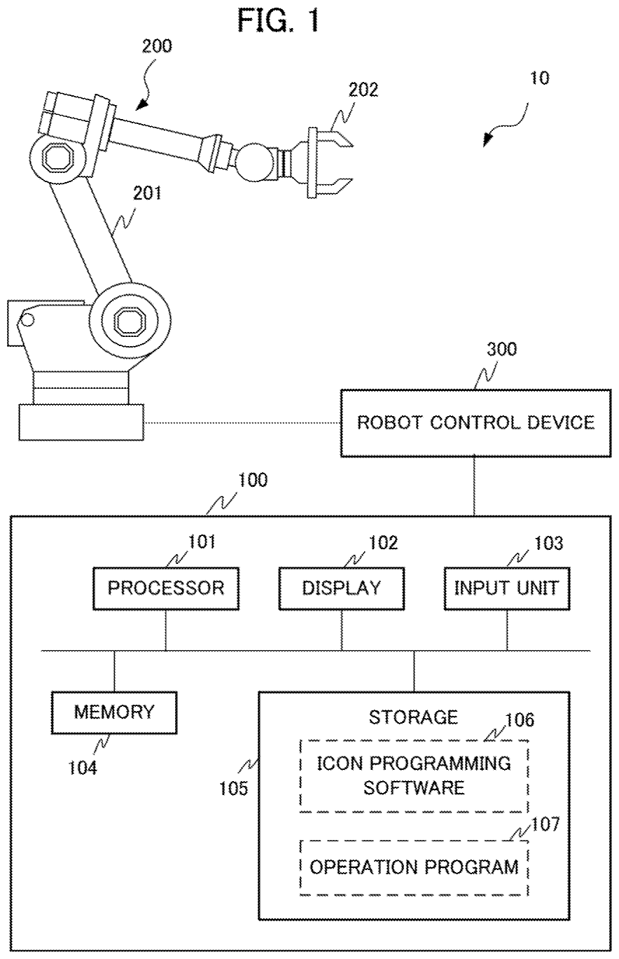

FIG. 1 is a block diagram illustrating a robot system including a robot teaching device of a first embodiment of the present disclosure. As shown in FIG. 1, a robot system 10 includes a robot teaching device 100, a robot 200, and a robot control device 300. The robot teaching device 100 is constituted of a computer including components such as a processor 101, a display 102, an input unit 103, memory 104, and a storage 105. The processor 101 is, for example, a central processing unit (CPU) or a quantum processor. The display 102 is, for example, a liquid crystal display or an organic EL display. The input unit 103 is, for example, a keyboard, a mouse, or a touch screen. The display 102 and the input unit 103 may be integrated into a liquid crystal display equipped with a touch screen. The memory 104 is provided to store data that the processor 101 temporarily requires to execute a program and is, for example, a DRAM. The storage 105 is, for example, a hard disk or a solid state drive (SSD). The storage 105 stores an operating system (OS) and icon programming software 106. The icon programming software 106 is a program for generating a robot program. The processor 101 reads the icon programming software 106 from the storage 105 and executes the icon programming software 106. The icon programming software 106 is an event-driven program that shows a program editing screen on a display screen of the display 102 and generates an operation program 107 of the robot 200 based on information from the input unit 103.

The robot teaching device 100 transmits the generated operation program 107 to the robot control device 300 via wire or wirelessly. The robot control device 300 controls motions of a robot mechanism 201 and tool 202 of the robot 200 in accordance with the operation program 107. The robot mechanism 201 is an industrial robot such as an articulated robot and a parallel link robot or a humanoid robot. A suction hand, a gripping hand, a welding tool, or a thread fastening tool is used as the tool 202, depending on the work of the robot 200.

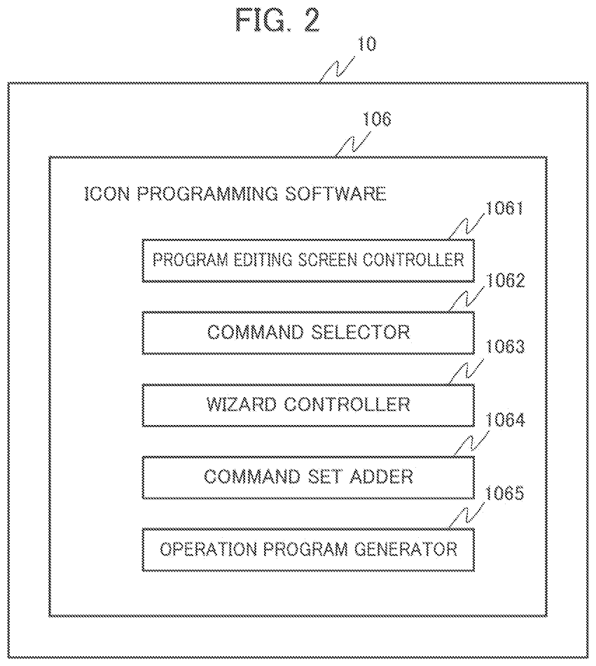

FIG. 2 is a functional block diagram of the robot teaching device realized by the icon programming software. This functional block diagram is realized by collaboration of hardware of a computer serving as the robot teaching device shown in FIG. 1 and the icon software program. The icon programming software 106 allows the robot teaching device 100 to function as a program editing screen controller 1061, a command selector 1062, a wizard controller 1063, a command set adder 1064, and an operation program generator 1065.

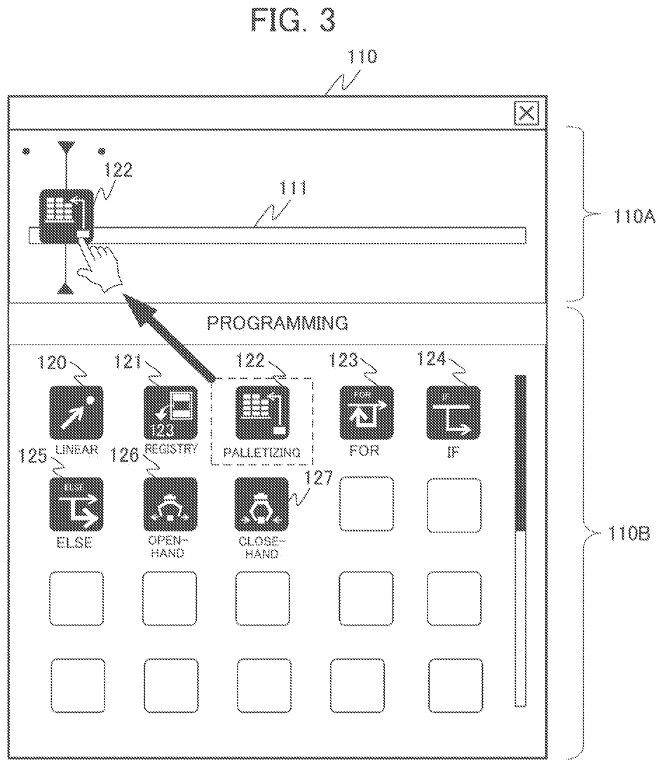

FIG. 3 is a view illustrating examples of the program editing screen and icons. In FIG. 3, icons that can be used for palletizing are shown with reference numbers, and other icons are shown as squares with rounded corners. The processor 101 functions as the program editing screen controller 1061 and shows the program editing screen 110 shown in FIG. 3 on the display 102. The program editing screen controller 1061 includes an area 110A showing a program line 111 on which icons indicating robot commands of the robot 200 (will be hereinafter referred to as “commands”) are placed in order of processing, and an icon arrangement area 110B in which icons are arranged in a matrix.

The icon 120 is an icon indicating a linear motion command that causes the tool 202 to move linearly. The icon 121 is an icon indicating a read out command that instructs reading of information required to start the robot program from a registry. The icon 122 is an icon indicating a command that instructs palletizing to stack workpieces on a pallet, or depalletizing to remove the workpieces from the pallet (will be referred to as a “palletizing command”). The icon 123 is an icon indicating a FOR command. The icon 124 is an icon indicating an IF command. The icon 125 is an icon indicating an ELSE command. The icon 126 is an icon indicating an open-hand command that instructs a gripping hand used as the tool 202 to open. The icon 127 is an icon indicating a close-hand command that instructs the gripping hand used as the tool 202 to close.

When added to the robot program, the palletizing command is accompanied by the addition of a set of commands, for example, the linear motion command that causes the gripping hand to move linearly and the open-hand command that causes the gripping hand to open. Thus, when added to the program, the command that is accompanied by the addition of at least one command other than the added command itself will be referred to as a representative command. The command other than the palletizing command, such as the command to instruct the tool 202 to move linearly, the command to instruct reading of information required to start the robot program from the registry, and the FOR command, is not accompanied by the addition of other commands when the command is added to the robot program, and thus is referred to as a general command. The command that is added concomitantly with the representative command is, for example, a general command. Examples of the representative command include, in addition to the palletizing command, a spot welding command that instructs spot welding of one or more welding points and a screw tightening command that instructs tightening of one or more screws. As mentioned above, the command includes the representative command and the general command. When simply referred to as a “command”, the command does not specify any particular instruction unlike the palletizing command and the FOR command and indicates as encompassing both of the representative command and general command.

Although it will be described below an example of generating a robot program for the palletizing, the present embodiment is also applicable to the generation of a robot program for the welding or the screw tightening.

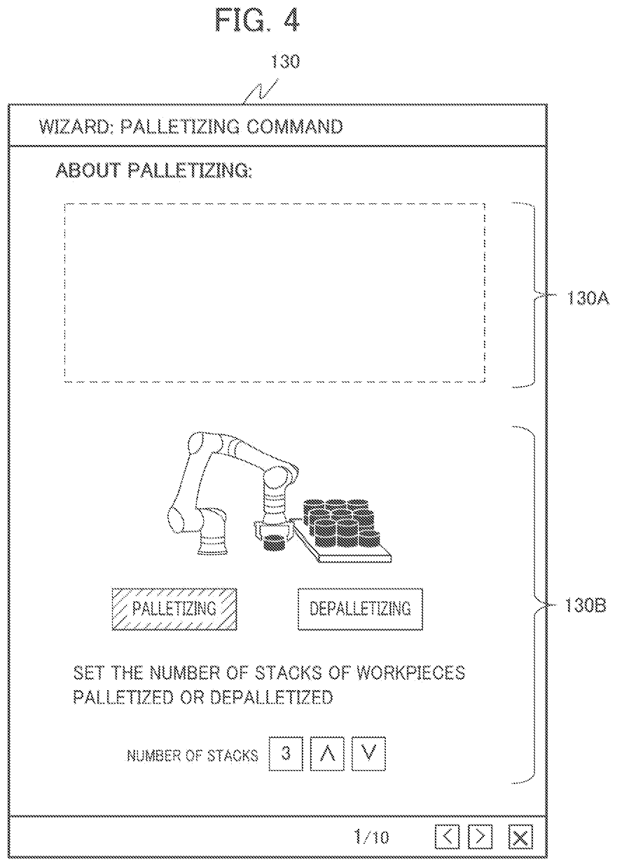

The processor 11 functions as the command selector 1062. When the user drags and drops the icon 122 indicating the palletizing command with a mouse onto the program line 111 on the program editing screen 110 shown in FIG. 3, the command selector 1062 places a copy of the icon 122 on the program line 111 and adds the palletizing command to the robot program. The processor 11 also functions as the wizard controller 1063. When the user places the icon 122 indicating the palletizing command onto the program line 111 on the program editing screen 110 shown in FIG. 3, the wizard controller 1063 starts a palletizing wizard, i.e., changes the program editing screen 110 on the display 102 to a wizard screen 130 of the first page shown in FIG. 4 to prompt the user to enter the commands, such as the linear motion command to instruct the gripping hand used as the tool 202 to move linearly and the open-hand command to instruct the gripping hand to open, and parameters indicating conditions for the linear motion command and other commands. The wizard screen includes a first page until a tenth page.

FIG. 4 is a view illustrating an example of the wizard screen of the first page for the palletizing. The wizard screen 130 of the first page includes a section 130A and a section 130B. The section 130A shows the description of an array of icons of an example of a robot program to be added after the end of the palletizing wizard and the definition of the palletizing. The section 130B prompts the user to select the palletizing or the depalletizing and to enter the number of stacks of workpieces to be palletized or depalletized (will be the parameter of the work condition).

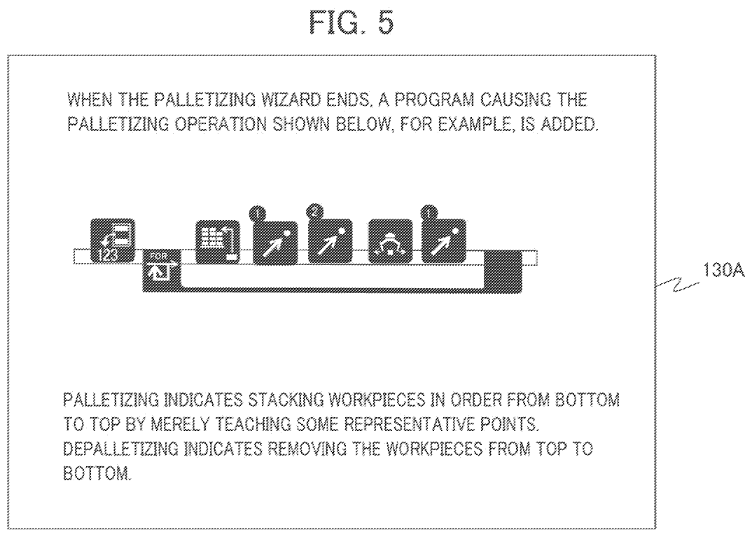

FIG. 5 is a view of the contents to be shown in the section 130A. As shown in FIG. 5, the section 130A shows the text “When the palletizing wizard ends, a program causing the palletizing operation shown below, for example, is added” and an example of the array of icons of the program to be added.

As shown in FIG. 5, the section 130A also shows “Palletizing is the stacking of workpieces in order from bottom to top by merely teaching some representative points. Depalletizing indicates removing the workpieces from top to bottom”.

As shown in FIG. 4, the section 130B shows a view of a palletizing operation, buttons to select the palletizing or the depalletizing, and an entry field for entering the number of the stacks. In FIG. 4, the “palletizing” is selected and three is entered as the number of the stacks. On the wizard screen 130, for example, the open-hand command that instructs the gripping hand to open indicated by the icon 126 is selected when the “palletizing” is selected, and the close-hand command that instructs the gripping hand to close indicated by the icon 127 is selected when the “depalletizing” is selected. In this case, the “palletizing” is selected, and thus the open-hand command that instructs the gripping hand to open indicated by the icon 126 is selected, and although the icon 126 is included in the area 110A of the program editing screen 110 shown in FIG. 8 to be referred later, when the “depalletizing” is selected, the icon 126 is replaced with the icon 127.

The parameter of the work condition entered on the wizard screen includes, in addition to the number of stacks of the workpieces palletized or depalletized, the numbers of rows and lines of the workpieces and the moving speed of the tool, which are entered on the wizard screens of the second page and the following pages. Thus, on the wizard screen 130 of the first page for the palletizing, the type of the icon (i.e., the type of the command) shown in the area 110A of the program editing screen 110 and the value of the parameter are determined.

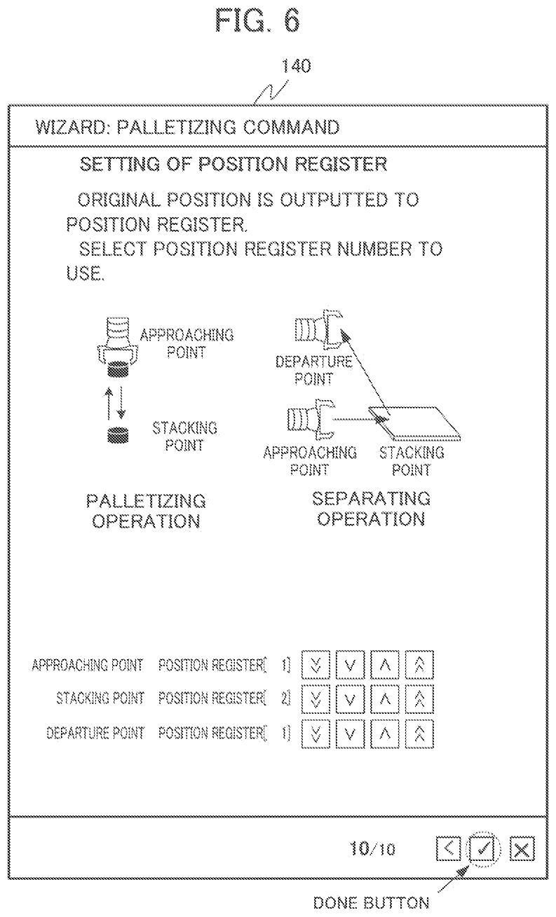

The user enters the parameters on each page of the wizard screens, starting from the wizard screen 130 of the first page for the palletizing shown in FIG. 4, until the wizard screen 140 of the last page for the palletizing shown in FIG. 6. FIG. 6 is a view illustrating an example of the wizard screen of the last page for the palletizing. The wizard screen 140 of the last page is used to set a position register. The operation of stacking the workpiece includes a palletizing operation of moving the gripping hand up and down between an approaching point and a stacking point and a separating operation of moving the gripping hand between the approaching point, the stacking point, and a departure point. On this screen, position register numbers (reg. nos.) of the approaching point and the stacking point are entered.

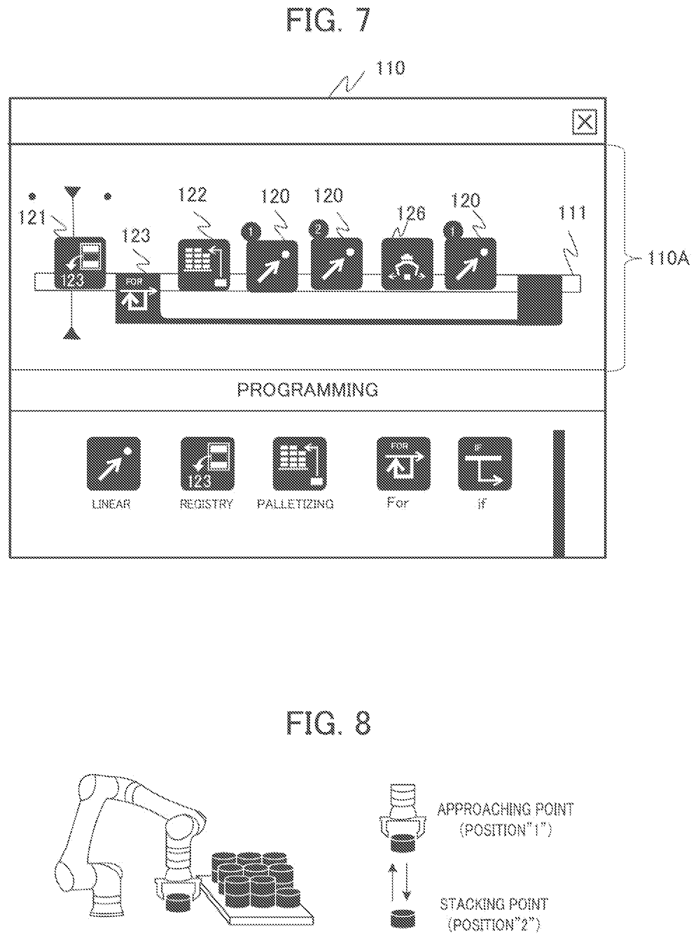

When the user clicks a Done button on the wizard screen 140 of the last page with a mouse, the command set adder 1064 adds a command set including the representative command (the palletizing command indicated by the icon 122) and the general command (the FOR command indicated by the icon 123) to the robot program. The program editing screen controller 1061 shows the program editing screen 110 again on the display screen. As shown in FIG. 7, the command set has been inserted in the area 110A on this program editing screen 110. FIG. 7 is a view illustrating part of the program editing screen with the command set inserted in the area 110A. The array of icons including the command set inserted in the area 110A will be described later.

The processor 11 functions as the operation program generator 1065 and converts, when the programming ends, the robot program into a format that the robot control device 300 is able to execute, such as a machine language, to generate an operation program 107. The robot teaching device 100 transmits the generated operation program 107 to the robot control device 300, and the robot control device 300 controls the operation of the robot mechanism 201 and tool 202 of the robot 200 in accordance with the operation program 107.

<Array of Icons with Inserted Command Set>

The array of icons inserted in the command set of the area 110A shown in FIG. 8 will be described below. The array of icons inserted in the command set of the area 110A shown in FIG. 7 indicates the following operations. In the array of the icons added, numerical values “1” and “2” on the icons 120 indicate positions to which the gripping hand of the robot moves. The command set adder 1064 displays the numerical values “1” and “2” on the icons 120. The icon 121 indicates that the robot program reads information required to start the robot program from the registry, the icon 123 indicates that the robot program repeats the processing of the icon 123 and the following icons (FOR command), and the icon 122 indicates that the robot program executes the palletizing or the depalletizing (palletizing command). Then, two icons 120 indicate that the gripping hand as the tool 202 moves to the positions specified by the values “1” and “2”, the icon 126 indicates that the gripping hand opens, and the icon 120 indicates that the gripping hand moves (returns) to the position specified by the value “1”.

Referring to FIGS. 7 and 8, the stacking operation of the gripping hand in the array of the icons of the robot program added will be described in detail below. FIG. 8 is a view illustrating the stacking operation of the gripping hand. The stacking by the gripping hand is achieved by the following processing steps (1) to (6).
(1) The robot teaching device 100 performs position calculation on the palletizing command indicated by the icon 122 to output the positions “1” and “2”. The positions outputted are calculated based on the information of the numbers of rows and lines of the workpieces on the pallet. For example, the positions outputted are calculated based on the numbers of lines, rows, and stacks, and the order of stacking.
(2) On the linear motion command indicated by the icon 120 with the position “1” added, the robot control device 300 moves the gripping hand as the tool 202 to the position “1” (approaching point). If the gripping hand directly moved to the position of the workpiece to be handled, since there is a possibility of contacting with other workpieces, the gripping hand is made to pass the approaching point above the workpiece.
(3) On the linear motion command indicated by the icon 120 with the position “2” added, the robot control device 300 moves the gripping hand to the position “2” (stacking point).
(4) On the command that instructs the gripping hand to open indicated by the icon 126, the robot control device 300 opens the gripping hand to place the workpiece.
(5) On the linear motion command indicated by the icon 120 with the position “1” added, the robot control device 300 moves the gripping hand to the position “1” (departure point). The departure point is the same as the approaching point.
(6) On the FOR command indicated by the icon 123, the processing steps (1) to (5) are repeated to stack the workpieces as shown in FIG. 8.

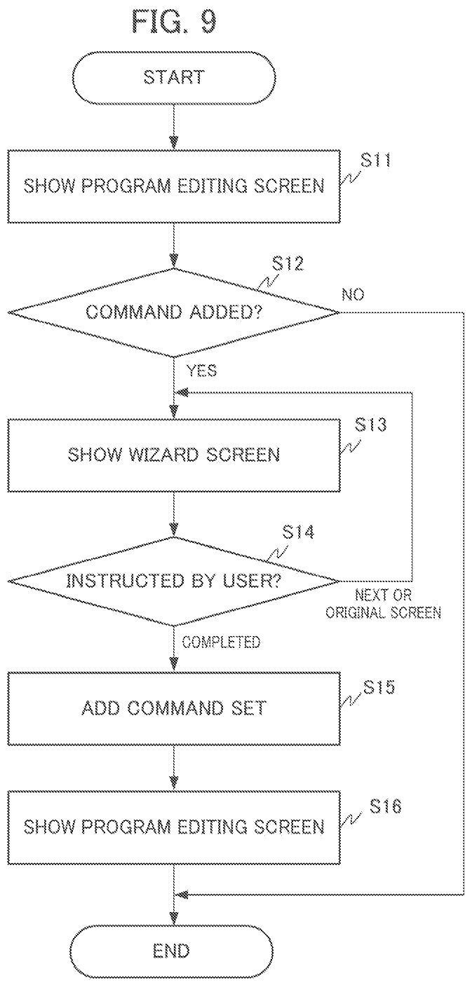

The operation of the robot teaching device 100 will be described below with reference to a flowchart of FIG. 9. FIG. 9 is a flowchart of the operation of the robot teaching device 100.

In Step S11, the program editing screen controller 1061 displays the program editing screen 110 shown in FIG. 3 on the display 102.

In Step S12, the wizard controller 1063 determines whether the icon indicating the palletizing is placed on the program line 111 and the palletizing command is added. The processing advances to Step S13 if the palletizing command is added, and the processing ends if not added.

In Step S13, the wizard controller 1063 displays the wizard screen 130 of the first page shown in FIG. 4 on the display 102. If the determination in Step S14 causes the processing to return from Step S14 and execute the processing of Step S13, the wizard controller 1063 displays the wizard screen of the next or original page on the display 102 in Step S13. When the user has input the parameters on the wizard screen 130 of the first page or the wizard screens of the second page and the following pages, the user instructs the wizard to display the wizard screen of the next or original page. When the wizard screen is the last page, the user instructs the wizard to end.

In Step S14, the wizard controller 1063 determines whether the user instructed the wizard screen of the next or original page to be shown or instructed the wizard to end. If the user instructed display of the next part or original wizard screen, the processing returns to Step S13. If the user instructed the wizard to end, the processing advances to Step S15.

In Step S15, the command set adder 1064 adds a command set including the representative command and the general command to the robot program. In Step S16, the program editing screen controller 1061 displays the program editing screen 110 with the icons of the command set placed on the program line 111 in the area 110A on the display 102.

In the embodiment described above, the wizard controller 1063 displays the wizard when the representative command is added to the robot program. However, the wizard controller 1063 may display the wizard when a general command, e.g., the linear motion command that instructs the tool to move linearly, is added to the robot program so that a parameter such as the moving speed of the tool is added.

In the embodiment described above, the wizard is automatically displayed when the icons are placed on the program line 111 in the area 110A of the program editing screen 110 and the commands of the robot program are added. This allows setting of the parameters of the general command and a plurality of commands including the representative command and the general command, added through the wizard. Thus, a beginner to robot operation, even if not having deep knowledge of the parameter for each command, etc., can create a complicated robot program by following the instructions of the wizard.

The icon programming software is stored in various types of non-transitory computer readable media and supplied to the computer. The non-transitory computer readable media include various types of tangible storage media. Examples of the non-transitory computer readable media include a magnetic recording medium (e.g., a hard disk drive), a magneto-optical recording medium (e.g., a magneto-optical disk), a compact disc read only memory (CD-ROM), a CD-R, a CD-R/W, and semiconductor memory (e.g., mask ROM, programmable ROM (PROM), erasable PROM (EPROM), flash ROM, and random access memory (RAM)).

### Second Embodiment

In the first embodiment, when the user adds the icon 122 indicating the palletizing onto the program line 111 on the program editing screen 110 as shown in FIG. 3, the wizard controller 1063 displays the wizard screen 130, whereby the addition of the general command and setting of parameters through the wizard is enabled.

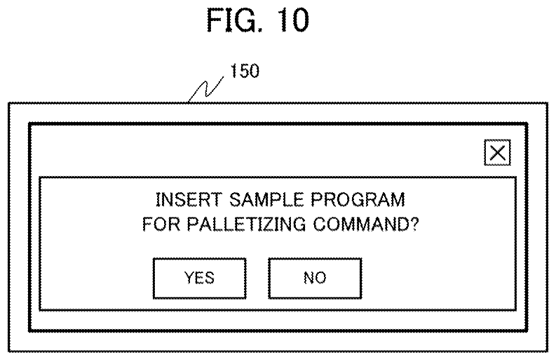

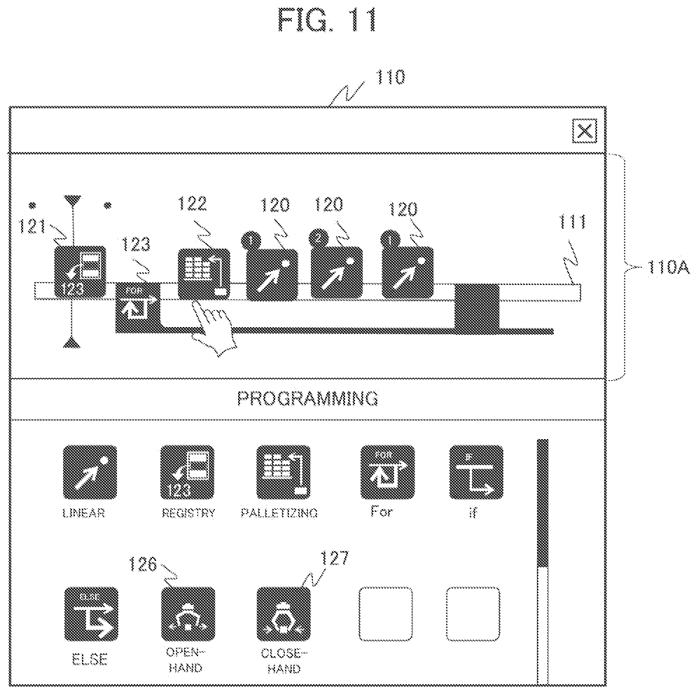

In the present embodiment, when the user adds the icon 121 indicating the palletizing onto the program line 111 on the program editing screen 110 as shown in FIG. 3, a pop-up window controller displays a pop-up window 150 shown in FIG. 10 on the program editing screen 110. When the user permits a sample program to be inserted, the pop-up window controller adds a command set including the representative command and the general command (a command set generated by adding the general command to a command set) to the area 110A of the program editing screen 110 shown in FIG. 11.

A designer determines and implements whether the program editing screen is switched to the wizard screen as in the first embodiment or the pop-up window is shown as in the present embodiment. The designer implements suitable processing on each of the wizard screen and the pop-up window depending on the work of the robot. For example, the wizard screen is shown for the palletizing, and the pop-up window is shown for the spot welding.

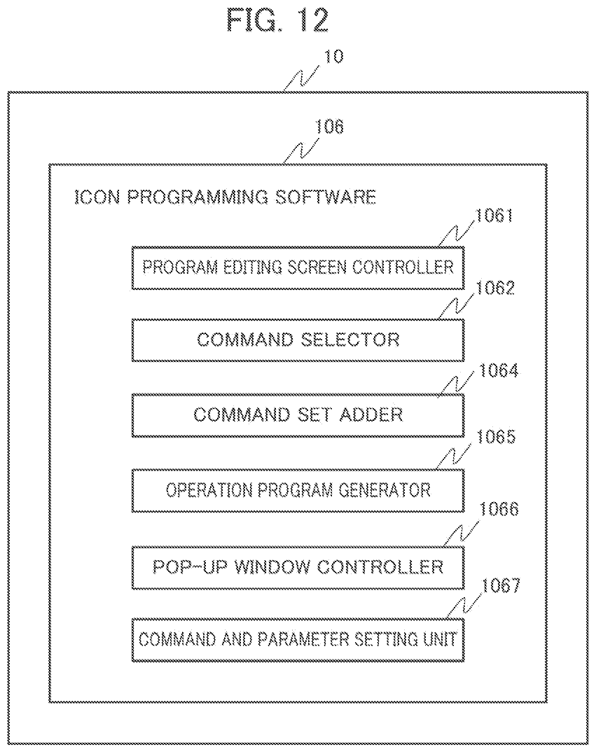

A robot system of the present embodiment is configured in the same manner as the robot system shown in FIG. 1 other than the feature described below. FIG. 12 is a functional block diagram of a robot teaching device of the present embodiment. A difference from the functional block diagram shown in FIG. 2 is in the point that a pop-up window controller 1066 and a command and parameter setting unit 1067 are provided in place of the wizard controller 1063. The pop-up window is shown to ask the user whether to insert a sample program for the palletizing prepared in advance as shown in FIG. 10. When the icon 122 indicating the palletizing is placed on the program line 111 on the program editing screen 110 shown in FIG. 3 as in the first embodiment, the pop-up window controller 1066 shows the pop-up window 150 shown in FIG. 10.

When the user selects “YES” on the pop-up window 150 shown in FIG. 10, the command set adder 1064 adds a set of icons to the program line 111 in the area 110A on the program editing screen 110 as shown in FIG. 11 to generate a command set.

The command set shown in FIG. 11 does not include the parameters such as the number of stacks. Thus, the command and parameter setting unit 1067 sets the parameters of the representative command and the general command. For example, when the user clicks the icon 122 indicating the palletizing as shown in FIG. 11, the command and parameter setting unit 1067 shows a parameter setting screen. When the user enters the number of stacks of workpieces palletized on the parameter setting screen, the command and parameter setting unit 1067 sets the number in the palletizing command. For the command set shown in FIG. 11, the user is required to select one of the general command to open the gripping hand or the general command to close the gripping hand and add the icon 126 or the icon 127. When the user drags the icon 126 of the command to open the gripping hand with a mouse and drops the icon 126 between the icon 120 with the position “2” and the icon 120 with the position “1” on the right of the former icon 120, the command and parameter setting unit 1067 sets the same command set as the command set shown in FIG. 7.

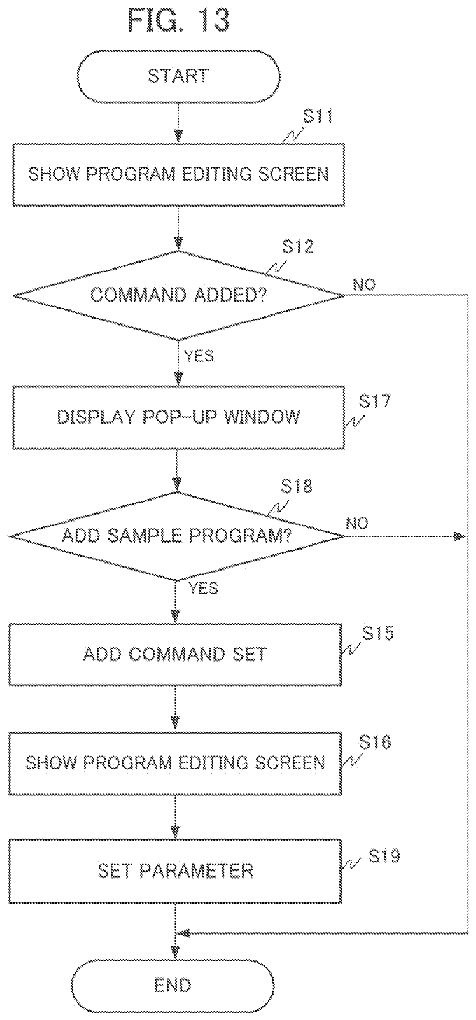

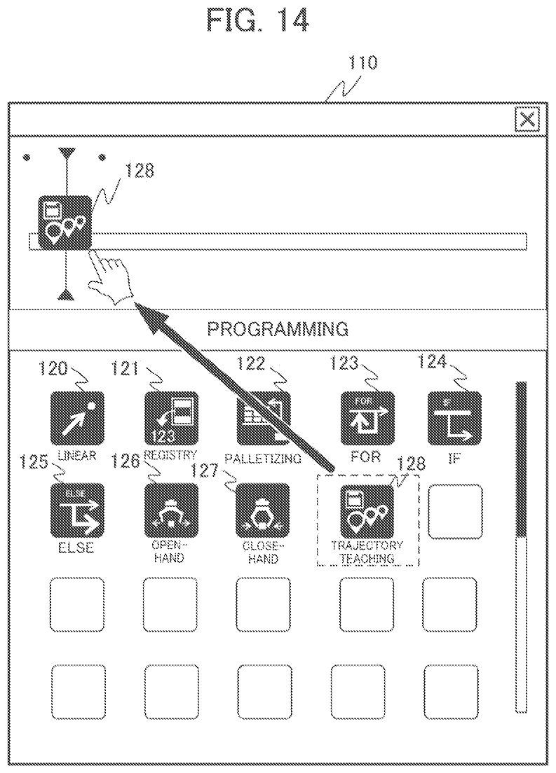

Then, the operation of the robot teaching device 100 of the present embodiment will be described below with reference to a flowchart of FIG. 13. FIG. 13 is a flowchart of the operation of the robot teaching device 100 of the present embodiment. In the flowchart of FIG. 13, unlike the flowchart shown in FIG. 9, the pop-up window controller 1066 is used in place of the wizard controller 1063 in Step S12, Steps S13 and S14 are replaced with Step S17 and S18, and Step S19 is added.

In Step S11, the program editing screen controller 1061 displays the program editing screen 110 shown in FIG. 3 on the display 102.

In Step S12, the pop-up window controller 1066 determines whether the icon 122 indicating the palletizing is placed on the program line 111. The processing advances to Step S17 if the palletizing icon is added, and the processing ends if not added.

In Step S17, the pop-up window controller 1066 displays the pop-up window shown in FIG. 10 on the display 102.

In Step S18, the pop-up window controller 1066 causes the processing to advance to Step S15 if the user selects “YES” as the answer to whether to insert the sample program for palletizing, and ends the processing if “NO” is selected.

In Step S15, a command set for palletizing is inserted. In Step S16, the program editing screen controller 1061 displays the program editing screen 110 with the icons of the command set placed on the program line 111 in the area 110A on the display 102.

In Step S19, additional representative command and general command and their parameters are set. For example, the command to open or close the gripping hand and the parameter such as the number of stacks of the workpieces palletized are set.

In the first embodiment, the wizard screen is used for detailed setting, and the command set is added to follow the palletizing command after the wizard ends. Thus, the user is able to see the array of icons including the added command set on the program editing screen 110 after the wizard ends. On the other hand, in the present embodiment, a set of a plurality of commands is added when the representative command is added, allowing the user to visually check the command set. This allows the user to add the general command to the checked command set, and set the parameters by selecting the representative command and the general command.

### Third Embodiment

FIG. 14 is a view illustrating an example of a program editing screen of a robot teaching device of a third embodiment of the present disclosure. In FIG. 14, an icon 128 indicating a trajectory teaching command is added to the area 110A shown in FIG. 3 and the icon 122 indicating the palletizing command in the icon arrangement area 110B is replaced with the icon 128 indicating the trajectory teaching command. The trajectory teaching command is the representative command.

Although the functional blocks of the robot teaching device implemented by the icon programming software are the same as those shown in FIG. 2, the command set adder 1064 of the present embodiment deletes the icon 128 indicating the trajectory teaching command after the wizard ends, and adds a command set including the linear motion command indicated by the icon 120, which is the general command, to the robot program.

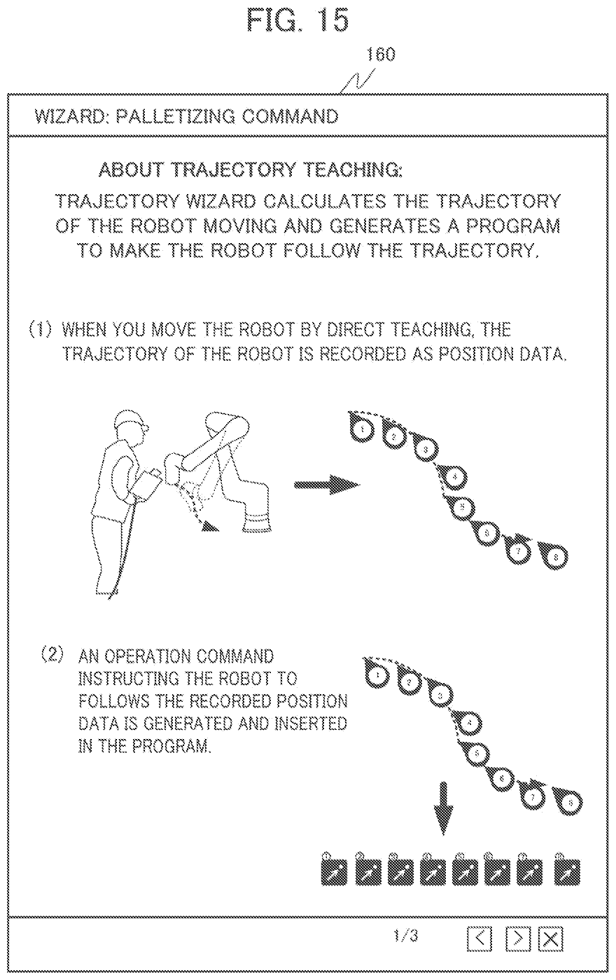

When the user adds the icon 128 indicating the trajectory teaching command to the program line 111 on the program editing screen 110 shown in FIG. 14, the processor 11, which functions as the wizard controller 1063, starts a trajectory teaching wizard and changes the program editing screen 110 on the display 102 to a wizard screen 160 shown in FIG. 15 to prompt the user to enter work conditions, etc. The wizard screen includes a first page until a third page.

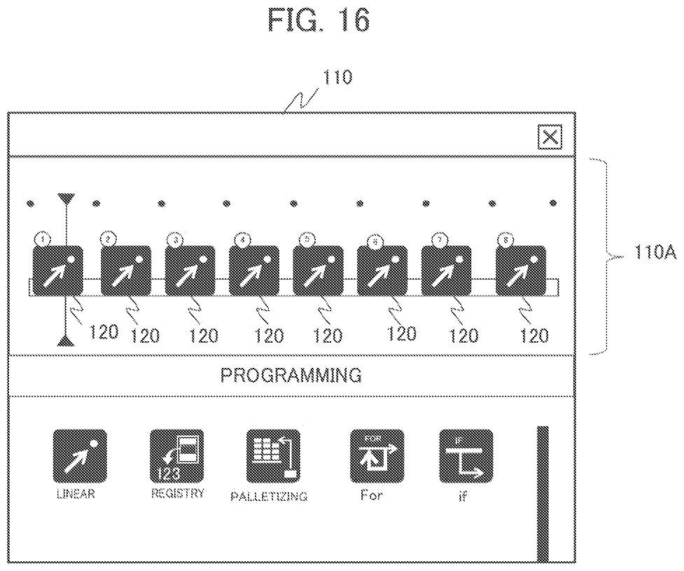

FIG. 15 is a view illustrating an example of the wizard screen of the first page for the trajectory teaching. The wizard screen 160 of the first page shows the text “Trajectory wizard can calculate the trajectory of the robot moving and generate a program to follow the trajectory” in a section for the description of the trajectory teaching. A section for the description of trajectory teaching operation shows the texts “(1) When you move the robot by direct teaching, the trajectory of the robot is recorded as position data” and “(2) An operation command instructing the robot to follow the recorded position data is generated and inserted in the program”, with illustrations of the texts (1) and (2). When the user moves the robot in an S-shaped pattern by direct teaching with an operating terminal, position data including positions “1” to “8” is stored, and a command set including eight icons 120 having the positions “1” to “8” is generated and inserted in the robot program. When the user presses a Done button on the third page (last page), the trajectory teaching wizard ends, and the program editing screen 110 is shown again on the display screen. In the area 110A of the program editing screen 110 shown in FIG. 16, the icon 128 indicating the trajectory teaching is deleted, and the command set including eight linear motion commands indicated by the eight icons 120 with the positions “1” to “8” is inserted.

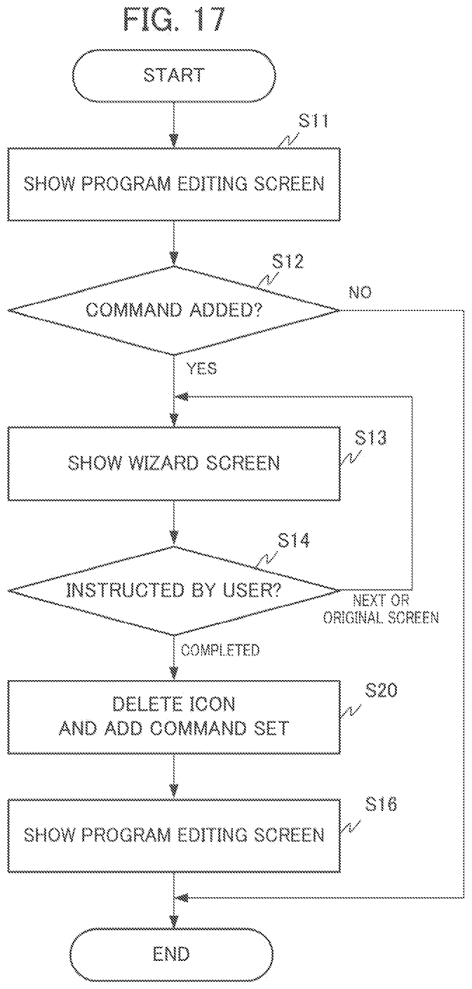

The operation of the robot teaching device 100 of the present embodiment will be described below with reference to a flowchart of FIG. 17. FIG. 17 is a flowchart of the operation of the robot teaching device 100 of the present embodiment. In the flowchart of FIG. 17, unlike the flowchart shown in FIG. 9, the icon 122 indicating the palletizing command is replaced with the icon 128 indicating the trajectory teaching command, and Step S15 is replaced with Step S20.

In Step S11, the program editing screen controller 1061 shows the program editing screen 110 shown in FIG. 14 on the display 102.

In Step S12, the wizard controller 1063 determines whether the icon indicating the trajectory teaching command is added to the program line 111. The processing advances to Step S13 if the trajectory teaching command is added, and the processing ends if not added.

In Step S13, the wizard controller 1063 displays the wizard screen 160 of the first page shown in FIG. 15 on the display 102. If the determination in Step S14 causes the processing to return from Step S14 and perform the processing of Step S13, the wizard controller 1063 displays the wizard screen of the next or original page on the display 102 in Step S13. When the user has entered the parameters on the wizard screen 160 of the first page or the wizard screens of the second page and the following pages, the user instructs the wizard to display the wizard screen of the next or original page. When the wizard screen of the last page is on the display, the user instructs the wizard to end.

In Step S14, when the wizard controller 1063 determines that the user instructed the wizard screen of the next or original page to be displayed, the processing returns to Step S13. When it is determined that the user instructed the wizard to end, the processing advances to Step S20.

In Step S20, the command set adder 1064 deletes the icon 128 indicating the trajectory teaching and adds the command set to the robot program.

In Step S16, the program editing screen controller 1061 displays the program editing screen 110 with the icons of the command set placed on the program line 111 in the area 110A on the display 102.

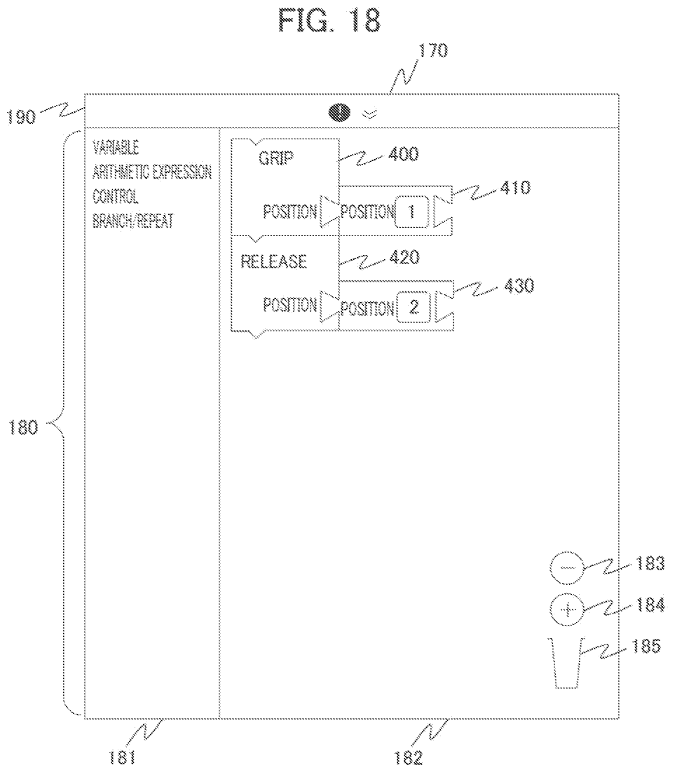

The aforementioned first, second, and third embodiments are preferred embodiments of the present invention; however, the scope of the present invention is not to be limited to the first, second, and third embodiments. Implementation is possible in modes achieved by conducting various modifications of a scope not departing from the spirit of the present invention. For example, the commands indicated by the icons in the first, second, and third embodiments may be indicated by blocks as shown in FIG. 18.

FIG. 18 is a view illustrating an example of a program editing screen using blocks. A program editing screen 170 includes a programming area 180 and a screen selector area 190. The programming area 180 includes a function selector area 181 and a block arrangement area 182. The block arrangement area 182 shows a reduce button 183 to reduce the size of the blocks in the block arrangement area 182, an enlarge button 184 to enlarge the size of the blocks in the block arrangement area 182, and a trash can 185 for deleting the blocks. For example, as shown in FIG. 18, when the user selects “control” in the function selector area 181, a block 400 indicating a command that instructs a hand to grip a workpiece and a block 420 indicating a command that instructs the hand to release the workpiece are displayed in the block arrangement area 182. These commands are the general commands. Then, a wizard is displayed in the same manner as in the first embodiment. When the user sets the position “1” of the hand to grip the workpiece and the position “2” of the hand to release the workpiece, and the entry through the wizard ends, a block 410 indicating the position “1” is joined with the block 400, and a block 430 indicating the position “2” is joined with the block 420.

In this example, the wizard is used to set the position concerning the general command. However, this is also applicable to an example in which the wizard is displayed for the representative command such as the palletizing command as in the first embodiment, an example in which a command set including the palletizing command and the general command is added concomitantly with the representative command such as the palletizing command as in the second embodiment, and an example in which the wizard is shown for the representative command such as the trajectory teaching command and the representative command such as the trajectory teaching command is deleted after the wizard ends as in the third embodiment.

The robot teaching device and the program for generating a robot program of the present disclosure can be achieved in the form of various embodiments having the following such configurations in addition to the above-described embodiments. (1) A robot teaching device, including: a display (e.g., a display 102); an editing screen controller (e.g., a program editing screen controller 1061) that displays an editing screen for editing a robot program that teaches a robot to move on the display; and a wizard controller (e.g., a wizard controller 1063) that displays, when a robot command is added to the robot program on the editing screen, a wizard for setting at least a parameter value of the robot command on the display. By displaying the wizard, this robot teaching device can achieve advanced teaching by way of the flow of the robot program. This facilitates understanding of the sequence of program creation and can reduce the time and effort in program creation.

(2) A robot teaching device, including: a display (e.g., a display 102); an editing screen controller (e.g., a program editing screen controller 1061) that displays an editing screen for editing a robot program that teaches motions of a robot on the display; and a command adder (e.g., a command adder 1064) that adds, when a robot command is added to the robot program on the editing screen, at least one other robot command other than the added robot command to the robot program. This robot teaching device can add a plurality of commands with fewer operations. The robot teaching device can achieve advanced teaching by way of the flow of the robot program. This facilitates understanding of the sequence of program creation and can reduce the time and effort in program creation.

(3) A robot teaching device, including: a display (e.g., a display 102); an editing screen controller (e.g., a program editing screen controller 1061) that displays an editing screen for editing a robot program that teaches a robot to move on the display; and a wizard controller (e.g., a wizard controller 1063) that displays, when a robot command is added to the robot program on the editing screen, a wizard for adding at least one other robot command other than the added robot command to the robot program, in which the robot command added on the editing screen is a representative command that is accompanied by addition of at least one other robot command other than the added robot command, and the representative command is deleted from the robot program after the wizard ends. With this robot teaching device, the robot command is added and the representative command that ended the teaching is deleted through the wizard. Thus, commands unnecessary for the robot motion can be deleted.

(4) In the robot teaching device of aspect (1), the robot command added on the editing screen is a representative command that is accompanied by addition of at least one other robot command other than the added robot command, when the representative command is added to the robot program, the wizard adds the at least one other robot command other than the added robot command, and the wizard combines the representative command and the at least one other robot command added concomitantly with the representative command and sets a parameter value of the representative command and a parameter value of the at least one other robot command.

(5) In the robot teaching device of aspect (2), the robot command added on the editing screen is a representative command that is accompanied by addition of at least one other robot command other than the added robot command, and the robot teaching device further includes a setting unit that sets a parameter of the representative command and a parameter of the at least one other robot command added by the command adder.

(6) In the robot teaching device of aspect (3), the wizard sets a parameter value of the at least one other robot command.

(7) In the robot teaching device as described in any one of aspects (1) to (6), the robot command is indicated by an icon or a block, and the editing screen controller edits the robot program by the icon or the block being added.

(8) In a program for generating a robot program, the program causes a computer as a robot teaching device to execute: a function of displaying an editing screen for editing a robot program that teaches motions of a robot on a display; and a function of displaying, when a robot command is added to the robot program, a wizard for setting at least a parameter value of the robot command on the display in the editing screen. By displaying the wizard, this generating program enables advanced teaching by way of the flow of the robot program. This facilitates understanding of the sequence of program creation and can reduce the time and effort in program creation.

(9) In a program for generating a robot program, the program causes a display to execute a function of displaying an editing screen for editing a robot program that teaches motion of a robot on a display; and a function of adding, when a robot command is added to the robot program, at least one other robot command other than the added robot command to the robot program on the editing screen. This program can add a plurality of commands with fewer operations. The program enables advanced teaching by way of the flow of the robot program. This facilitates understanding of the sequence of program creation and can reduce the time and effort in program creation.

(10) In a program for generating a robot program, the program causes a computer as a robot teaching device to execute: a function of displaying an editing screen for editing a robot program that teaches motion of a robot on a display; and a function of displaying, when a robot command is added to the robot program, a wizard for adding at least one other robot command other than the added robot command to the robot program on the editing screen, in which the robot command added on the editing screen is a representative command that is accompanied by addition of at least one other robot command other than the added robot command, and the representative command is deleted from the robot program after the wizard ends. With this generating program, the robot command is added and the representative command that ended the teaching is deleted through the wizard. Thus, commands unnecessary for the robot motion can be deleted.

(11) In the program of aspect (8), the robot command added on the editing screen is a representative command that is accompanied by addition of at least one other robot command other than the added robot command, when the representative command is added to the robot program, the wizard adds the at least one other robot command other than the added robot command, and the wizard combines the representative command and the at least one other robot command added concomitantly with the representative command, and sets a parameter value of the representative command and a parameter value of the at least one other robot command.

(12) In the program of aspect (9), the robot command added on the editing screen is a representative command that is accompanied by addition of at least one other robot command other than the added robot command, and the program sets a parameter of the representative command and a parameter of the at least one other robot command added.

(13) In the program of aspect (10), the wizard sets a parameter value of the at least one other robot command.

(13) In the program as described in any one of aspects (8) to (13), the robot command is indicated by an icon or a block, and the program edits the robot program by the icon or the block being added.

### EXPLANATION OF REFERENCE NUMERALS

10 Robot system
101 Processor
102 Display
103 Input unit
104 Memory
105 Storage
106 Icon programming software
107 Operation program
100 Robot teaching device
200 Robot
201 Robot mechanism
202 Tool
300 Robot control device
1061 Program editing screen controller
1062 Command selector
1063 Wizard controller
1064 Command set adding unit
1065 Operation program generator
1066 Pop-up window controller
1067 Command and parameter setting unit

1. A robot teaching device, comprising:
a display;
an editing screen controller that displays an editing screen for editing a robot program that teaches motion of a robot the display; and
a wizard controller that displays, when a robot command is added to the robot program on the editing screen, a wizard for setting at least a parameter value of the robot command on the display.

2. A robot teaching device, comprising:
a display;
an editing screen controller that displays an editing screen for editing a robot program that teaches motion of a robot on the display; and
a command adder that adds, when a robot command is added to the robot program on the editing screen, at least one other robot command other than the added robot command to the robot program.

3. A robot teaching device, comprising:
a display;
an editing screen controller that displays an editing screen for editing a robot program that teaches motion of a robot on the display; and
a wizard controller that displays, when a robot command is added to the robot program on the editing screen, a wizard for adding at least one other robot command other than the added robot command to the robot program,
wherein
the robot command added on the editing screen is a representative command that is accompanied by addition of at least one other robot command other than the added robot command, and
the representative command is deleted from the robot program after the wizard ends.

4. The robot teaching device according to claim 2, wherein the robot command added on the editing screen is a representative command that is accompanied by addition of at least one other robot command other than the added robot command,
when the representative command is added to the robot program, the wizard adds the at least one other robot command other than the added robot command, and
the wizard combines the representative command and the at least one other robot command added concomitantly with the representative command, and sets a parameter value of the representative command and a parameter value of the at least one other robot command.

5. The robot teaching device according to claim 2, wherein the robot command added on the editing screen is a representative command that is accompanied by addition of at least one other robot command other than the added robot command, and
the robot teaching device further includes a setting unit that sets a parameter of the representative command and a parameter of the at least one other robot command added by the command adder.

6. The robot teaching device according to claim 3, wherein the wizard sets a parameter value of the at least one other robot command.

7. The robot teaching device according to claim 1, wherein the robot command is indicated by an icon or a block, and
the editing screen controller edits the robot program by the icon or the block being added.

8. A non-transitory computer readable recording medium encoded with a program for generating a robot program, the program causing a computer as a robot teaching device to execute:
a function of displaying an editing screen for editing a robot program that teaches motion of a robot on a display; and
a function of displaying, when a robot command is added to the robot program on the editing screen, a wizard for setting at least a parameter value of the robot command on the display.

9. A non-transitory computer readable recording medium encoded with a program for generating a robot program, the program causing a computer as a robot teaching device to execute: a function of displaying an editing screen for editing a robot program that teaches motion of a robot on a display; and
a function of adding, when a robot command is added to the robot program on the editing screen, at least one other robot command other than the added robot command to the robot program.

10. A non-transitory computer readable recording medium encoded with a program for generating a robot program, the program causing a computer as a robot teaching device to execute:
a function of displaying an editing screen for editing a robot program that teaches motion of a robot on a display; and
a function of displaying, when a robot command is added to the robot program on the editing screen, a wizard for adding at least one other robot command other than the added robot command to the robot program, wherein
the robot command added on the editing screen is a representative command that is accompanied by addition of at least one other robot command other than the added robot command, and
the representative command is deleted from the robot program after the wizard ends.

11. The non-transitory computer readable recording medium according to claim 8, wherein the robot command added on the editing screen is a representative command that is accompanied by addition of at least one other robot command other than the added robot command,
when the representative command is added to the robot program, the wizard adds the at least one other robot command other than the added robot command, and
the wizard combines the representative command and the at least one other robot command added concomitantly with the representative command, and sets a parameter value of the representative command and a parameter value of the at least one other robot command.

12. The non-transitory computer readable recording medium according to claim 9, wherein the robot command added on the editing screen is a representative command that is accompanied by addition of at least one other robot command other than the added robot command, and
the program sets a parameter of the representative command and a parameter of the at least one other robot command added.

13. The non-transitory computer readable recording medium according to claim 10, wherein the wizard sets a parameter value of the at least one other robot command.

14. The non-transitory computer readable recording medium of claim 8, wherein the robot command is indicated by an icon or a block, and
the program edits the robot program when the icon or the block is added.
